(19) United States
(12) Patent Application Publication
(10) Pub. No.: US 2012/0145508 A1
(43) Pub. Date: Jun. 14, 2012

(54) CORE PLATE WITH AN EXTRUDED SPLINE

(75) Inventors: Robert Alan Dziurda, Waterford, MI (US); Charles S. Davis, Livonia, MI (US)

(73) Assignee: GM GLOBAL TECHNOLOGY OPERATIONS LLC, Detroit, MI (US)

(21) Appl. No.: 12/967,837

(22) Filed: Dec. 14, 2010

(51) Int. Cl. F16D 13/38; F16D 13/64; F16D 13/60

(52) U.S. Cl. 192/70.11; 192/107 R

(57) ABSTRACT

A annular core plate for a multiplate clutch assembly includes a spline with a plurality of teeth. At least one of the plurality of teeth is either partially or fully extruded to a thickness greater than the thickness of a base material for the core plate. The spline may be disposed around the inner surface of the annular core plate or may be disposed around the outer surface of the core plate. The core plate can be a core plate associated with a friction plate or can be a core plate associated with a separator plate.

### FIELD

The present disclosure relates to a core plate for a clutch assembly. More specifically, the present disclosure relates to a core plate with an extruded spline.

### BACKGROUND

The statements in this section merely provide background information related to the present disclosure and may not constitute prior art.

A typical motor vehicle automatic transmission includes gear elements and multiplate clutches that are selectably engageable to establish one of several forward speed ratios between the transmission input and output shafts. The input shaft is coupled to the vehicle engine through a fluid coupling such as a torque converter, and the output shaft is coupled to the vehicle drive wheels through a differential gear set.

A multiplate clutch generally includes a set of friction plates, a set of separator plates, and a hub all of which are housed in a clutch case. Spline grooves in the clutch case engage with splines along the outer periphery of the separator plates and another set of spline grooves in the hub engage with splines around the inner surfaces of the friction plates. The separator plates and the friction plates are arranged alternately so that they can be engaged or disengaged with each other.

In general the contact area between each spline and respective spline groove results in high contact stresses. Accordingly, there is a need in the art for a multiplate clutch assembly with separator plates and friction plates with splines that have more contact area over each spline.

### SUMMARY

The present invention provides a core plate for a multiplate clutch assembly. The core plate is annular in shape and includes a spline with a plurality of teeth. At least one of the plurality of teeth is either partially or fully extruded. The spline may be disposed around the inner surface of the annular core plate or may be disposed around the outer surface of the core plate. The core plate can be a core plate associated with a friction plate or can be a core plate associated with a separator plate.

Some embodiments of the core plate may have one or more of the following advantages. Because the extruded teeth provide a larger contact area, the contact stresses are reduced. Hence, the mating surfaces of the clutch assembly components that engage the teeth may be made from a softer material than found in typical clutch assemblies. Because of the decreased contact stresses, a thinner friction core plate material may be used without impacting the performance or the robustness of the multiplate assembly.

Further, the contact area between each clutch plate creates heat when the clutch is engaged. Use of an extruded spline allows for a thinner friction core plate, which also allows for added thickness to the separator plate in a multiplate packaging environment; thereby adding thermal sink capacity to the clutch system, since the amount of heat that can be absorbed and dissipated is proportional to the thickness of the separator plates in the multiplate assembly.

In general, the increased contact area provided by the extruded spline can be utilized to allow the use of alternate spline materials for the friction clutch plate interface, such as, for example, Aluminum, Magnesium, or any other suitable material.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, like reference characters designate corresponding parts throughout the different views. In the drawings:

FIG. 1 is a schematic cross sectional view of a portion of a clutch assembly with a set of friction plate assemblies in accordance with the principles of the invention;

FIG. 2a is a front view of a core plate for the fiction plate assemblies of FIG. 1;

FIG. 2b is a close up view of a single spline of the core plate in the region 2b of FIG. 2a;

FIG. 2c is a close up view of a single spline in accordance with another embodiment of the present invention;

FIG. 3 is a front view of a core plate for a friction plate assembly in accordance with another embodiment of the present invention;

FIG. 4 is a side cross sectional view of a single sided friction plate assembly in accordance with the principles of the present invention;

FIG. 5 is a side cross sectional view of double side friction plate assembly in a accordance with the principles of the present invention; and

FIG. 6 is a schematic cross sectional view of a friction plate assembly and separator plate illustrating the extent of the extrusion depth of a splined core plate.

### DETAILED DESCRIPTION

The following description is merely exemplary in nature and is not intended to limit the present disclosure, application, or uses.

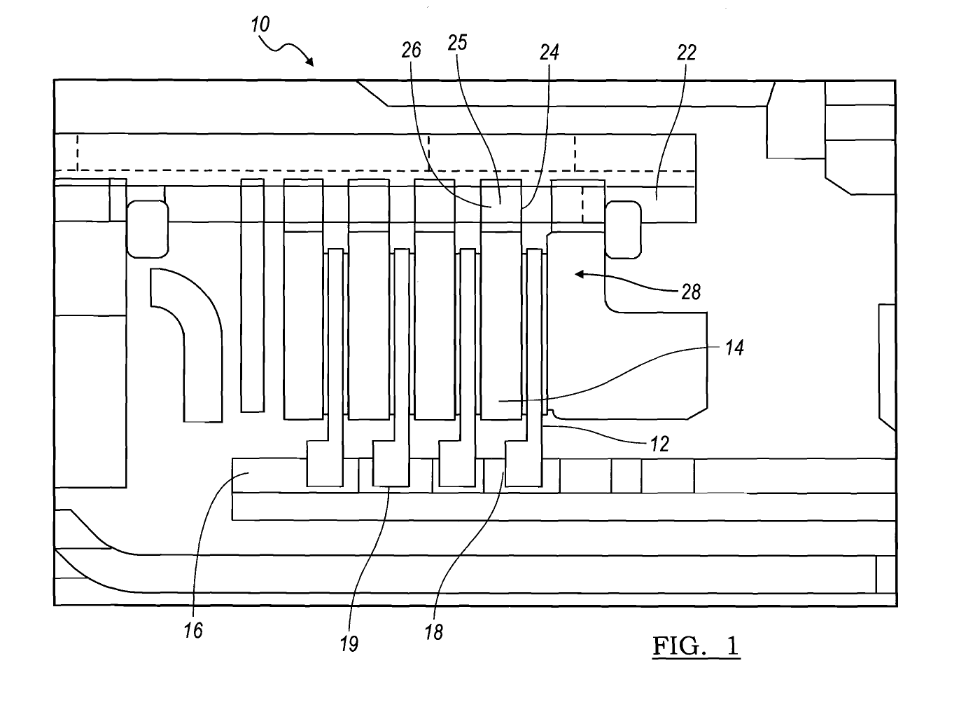

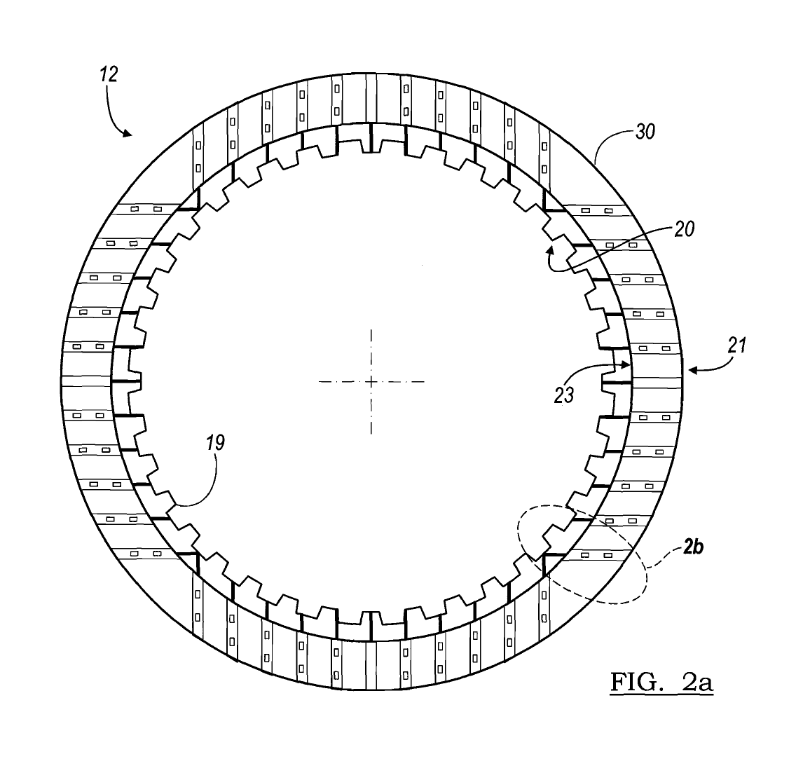

Referring now to FIGS. 1 and 2a, a clutch assembly embodying the principles of the present invention is illustrated therein and designated at 10. As its primary components, the clutch assembly 10 includes a set of annular shaped friction plates 12, each with an outer surface 21 and an inner surface 23, and a set of annular shaped separator plates 14 arranged alternately with the set of friction plates 12. The clutch assembly 10 further includes an inner member such as a hub 16 with a plurality of spline grooves 18, each of which selectively engages with a set of teeth 19 of a spline 20 associated with each friction plate 12 and an outer member such as a clutch case 22 with a plurality of spline grooves 24, each of which selectively engages with a set of teeth 25 of a spline 26 associated with each separator plate 14. To engage the clutch assembly 10, a piston head presses the separator plates 14 and the friction plates 12 together against a backing plate 28.

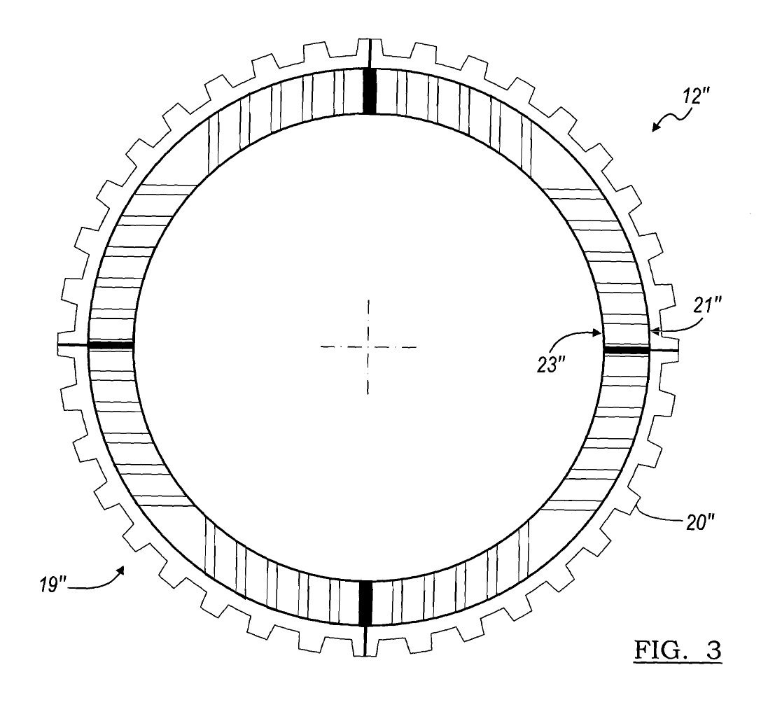

Referring further to FIG. 4, each friction plate 12 includes a core plate 30 and a layer of friction material 32. Each tooth 19 of the spline 20 can be fully extruded as shown in FIG. 2b. That is, the edges of each spline tooth is drawn into a C-section 34. Alternatively, each tooth of the spline 20 can be partially extruded; that is, each tooth is drawn with two side edges 36 and 38 as shown in FIG. 2c.

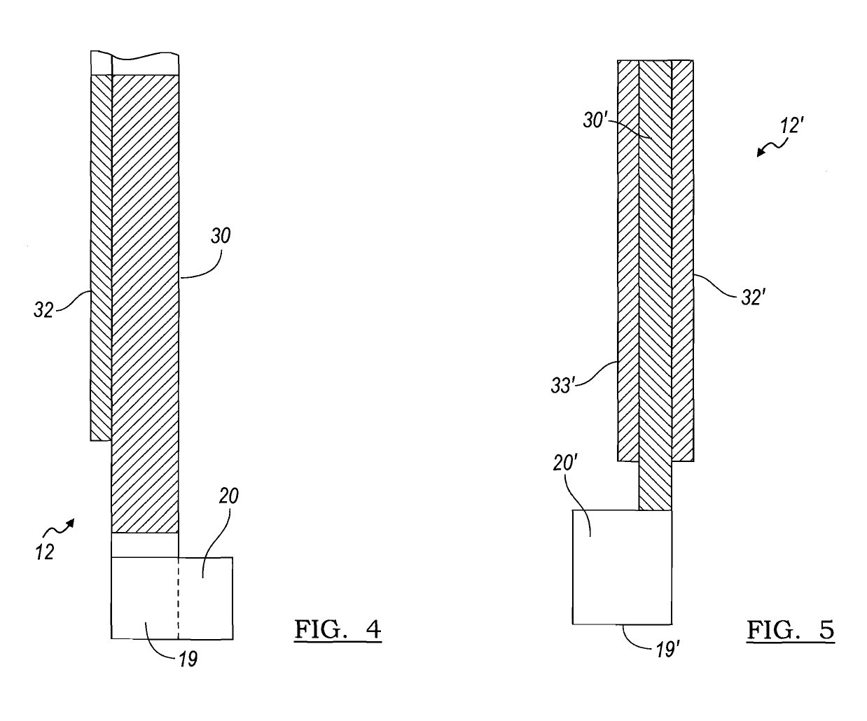

In another implementation as shown in FIG. 5, a friction plate 12′ includes a core plate 30′ and two layers of friction material 32′ and 33′. The spline 20′ associated the friction plate 12′ includes teeth 19′. The teeth 19′ may be fully extruded similar to the teeth 19 shown in FIG. 2b or may be partially extruded like the teeth 19 shown in FIG. 2c.

In alternative applications, a friction plate 12″ includes an outer surface 21″, an inner surface 23″, and a spline 20″ with extruded teeth 19″ around the outer surface 21″.

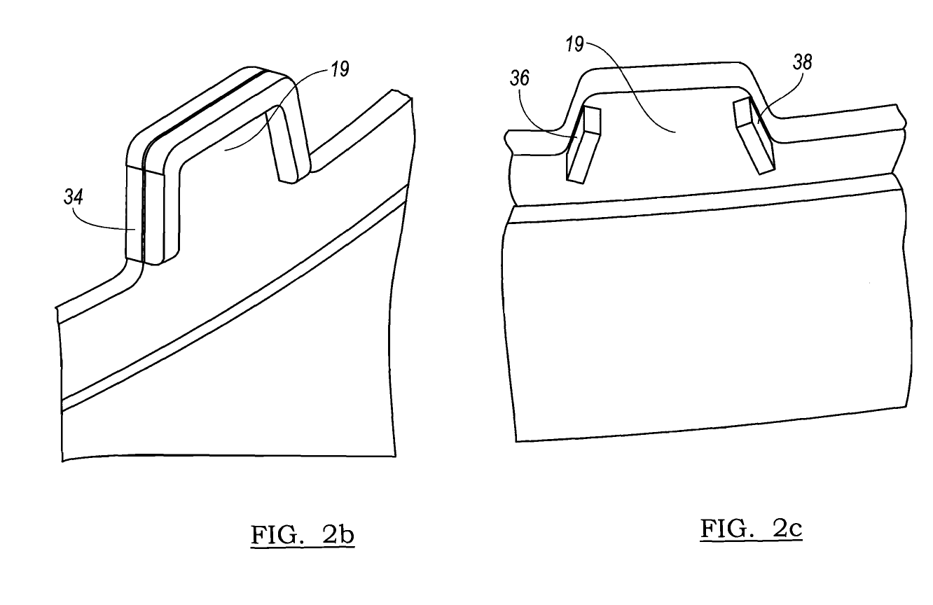

In yet other applications, the separator plate 14 may also include a core plate with an inner spline similar to the core plate shown in FIG. 2a or an outer spline similar to the core plate shown in FIG. 3. Accordingly, depending upon the application of the clutch assembly 10, the clutch assembly may include a friction plate with an inner splined core plate such and a separator plate with a core plate with an outer spline as depicted in FIG. 1. The splines associated with either or both of the core plates of the separator plates and the core plates of the friction plates can be extruded. The extruded splines may be partially or fully extruded. In other applications, the friction plate includes a core plate with an outer spline while the separator plate includes a core plate with an inner spline. Again, one of both splines associated with the friction plate and the separator plate may be partially or fully extruded.

In typical clutch assemblies, the hub 16 is made of steel. However, if extruded splines are employed, the contact area between the teeth of the splines and the spline groove in the hub increases and thereby decreases the contact stress between the hub and the teeth of the spline as compared to splines that are not extruded. Accordingly, with decreased contact stresses, a material softer than steel can be employed for the hub, such as, for example, aluminum. Alternatively, the hub can be steel, but the increased contact area associated with an extruded spline allows for the use of a thinner core plate. Hence, the mass is reduced, resulting in a cost reduction in the manufacturing of such core plates. In such arrangements, the separator plate can be thicker than a conventional separator plate to allow for a greater heat sink such that higher energy can run through the clutch assembly that occupies the same space, or, alternatively, more friction plates may be employed in the same space.

To make the teeth 19 or 19″ on the splines, each core plate associated with a friction plate or separator plate is initially stamped or fine blanked. Then the edges of the teeth are coined or drawn to form the extruded spline. That is, the outer edge of each tooth is folded down to form a fully extruded tooth as shown in FIG. 2b, or the two side edges are folded down to form a partially extruded tooth as shown in FIG. 2c. Alternatively, the extrusion of the teeth can be formed in a single die/fineblank process or in a progressive die process.

In sum, the use of friction plates with an extruded spline allows for reduced mass, greater choice in mating component materials, increased axial packaging flexibility, and allows greater clutch energy capacity that results from thinner friction core plates and thicker separator plates.

Depending on the application, certain teeth of a spline associated with either the separator plate or the friction plate may not be extruded. That is, for a particular inner or outer spline, some teeth may be extruded while others are not.

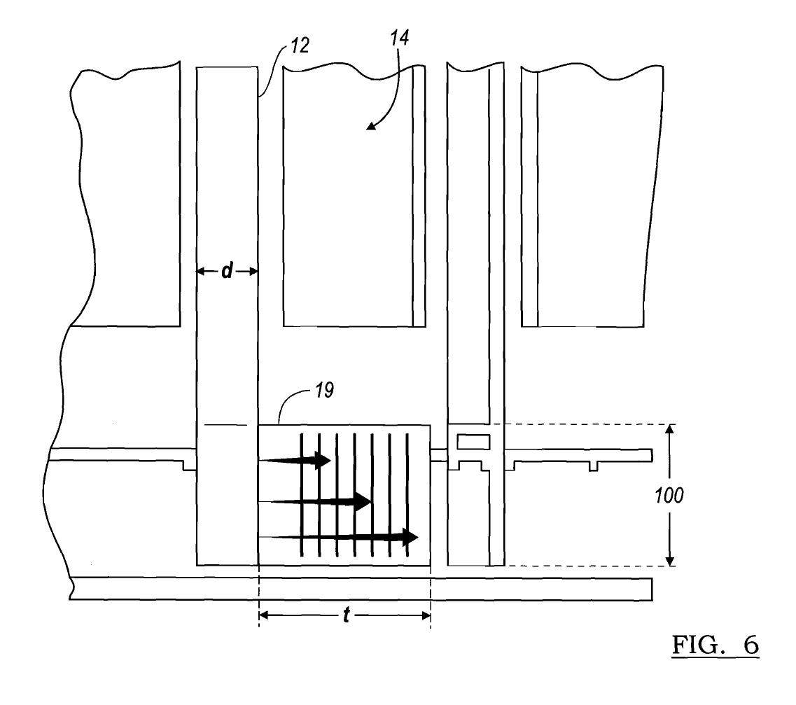

Referring to FIG. 6, note that in the spline contact area 100, the thickness, t, of the teeth 19 of a splined friction plate 12 can range from the core plate thickness, d, (that is, no extrusion) to the full thickness of the separator plate 14, t+d, where t is the thickness of the extruded portion of the teeth 19, depending on the desired performance and capability of the clutch assembly 10.

The description of the invention is merely exemplary in nature and variations that do not depart from the gist of the invention are intended to be within the scope of the invention. Such variations are not to be regarded as a departure from the spirit and scope of the invention.

What is claimed is:

1. A annular core plate for a multiplate clutch comprising:
an outer surface;
an inner surface; and
a spline disposed along one of the outer surface and the inner surface, the spline including a plurality of teeth; and
wherein at least one of the plurality of teeth is extruded.

2. The core plate of claim 1 wherein the spline is disposed around the outer surface of the core plate.

3. Then core plate of claim 1 wherein the spline is disposed around the inner surface of the core plate.

4. The core plate of claim 1 wherein the at least one of the plurality of extruded teeth is partially extruded.

5. The core plate of claim 1 wherein the at least one of the plurality of extruded teeth is partially extruded.

6. The core plate of claim 1 wherein the core plate is a core plate for a separator plate.

7. The core plate of claim 1 wherein the core plate is a core plate for a friction plate.

8. The core plate of claim 7 wherein the friction plate is a single side friction plate with a single layer of friction material.

9. The core plate of claim 7 wherein the friction plate is a double sided friction plate with a first layer of friction material and a second layer of friction material, the first layer of the friction material and the second layer of friction material be disposed on respective outer surfaces of the friction plate.

10. The core plate of claim 1 wherein the at least one of the plurality of teeth that is extruded has a thickness of about the thickness of a separator plate associated with the clutch.

11. The core plate of claim 1 wherein the core plate is made of steel.

12. A friction plate for a multiplate clutch assembly comprising:
a core plate with a spline, the spline including a plurality of teeth, at least one of the plurality of teeth being extruded; and
at least one layer of friction material disposed on a surface of the core plate.

13. The friction plate of claim 12 wherein the spline is disposed around an outer surface of the core plate.

14. The core plate of claim 12 wherein the spline is disposed around an inner surface of the core plate.

15. The core plate of claim 11 wherein the at least one of the plurality of extruded teeth is fully extruded.

16. The core plate of claim 1 wherein the at least one of the plurality of extruded teeth is partially extruded.

17. A multiplate clutch assembly comprising:
at least one annular separator plate; and
at least one annular friction plate with a core plate, the core plate including a spline with a plurality of teeth; and wherein at least one of the plurality of teeth is extruded.

18. The multiplate clutch assembly of claim 17 further comprising an inner member and an outer member, the separator plate and the friction plate being disposed alternately about the inner member, the separator plate, the friction plate, and the inner member being disposed in the outer member, wherein the plurality of teeth of the spline engages a spline groove in the inner member.

19. The multiplate clutch assembly of claim 17, wherein the separator plate includes a core plate with a spline having a plurality of teeth, at least one of the plurality of teeth associated with the separator plate being extruded, and wherein at least one of the extruded teeth associated with the separator plate engages with a spline groove in the outer member.

20. The multiplate clutch assembly of claim 16, wherein the spline associated with the core plate of the friction plate is a spline around the inner surface of the annular friction plate, and the spline associated with the separator plate is a spline around the outer periphery of the annular separator plate.
